(19) United States
(12) Patent Application Publication
(10) Pub. No.: US 2026/0106564 A1
(43) Pub. Date: Apr. 16, 2026

(54) INTEGRATED CHARGER UNIT WITH INVERTER AND MOTOR

(71) Applicant: Jacobi Motors, LLC, Missouri City, TX (US)

(72) Inventor: Ahmed Salah Morsy, Sugar Land, TX (US)

(73) Assignee: Jacobi Motors, LLC, Missouri City, TX (US)

(21) Appl. No.: 18/914,988

(22) Filed: Oct. 14, 2024

(51) Int. Cl. H02P 27/06; H02J 7/00; H02J 7/14; H02P 25/022

(52) U.S. Cl. CPC H02P 27/06; H02J 7/14; H02J 7/865; H02P 25/022

(57) ABSTRACT

An integrated charger unit including a synchronous motor comprising two or more phase winding sets, where the synchronous motor is operably magnetizable and de-magnetizable, and one or more inverter modules configured to allow power to be supplied to the synchronous motor and/or a battery. The charger unit is operably shiftable between at least one of, a driving mode where the inverter modules supply power from the battery through the phase winding sets to drive the synchronous motor, or a charging mode where power from an external power source is received by the inverter modules through the synchronous motor and supplied to the battery for charging, thereby adapting the synchronous motor to operate as a filter inductor, which reduces, cost, complexity, weight, and power ripples in the charger unit. Using multiple phase winding sets enables the charger unit to operate on a plurality of power phases.

### BACKGROUND

Synchronous electric motors have a wide range of applications in industrial, commercial, and residential, applications, such as fans, pumps, compressors, elevators, and refrigerators, industrial machinery, and electric motor vehicles because of their high efficiencies. Also, because of using permanent magnets instead of windings in the rotors of the synchronous electric motors, there is less need for rotor cooling. These advantages along with others (e.g., being brushless) make the synchronous electric motors popular where high torque, high efficiency, or low maintenance for electric motors is needed.

Many applications require synchronous electric motors to operate on power supplied by batteries. A predominant example of such an application is an electric vehicle, where the motors are powered by rechargeable batteries. Such batteries may be periodically brought to a charging station that provides necessary electric power to charge the batteries. Usually, charging stations provide electric power in the form of single-phase or three-phase Alternating Current (AC), based on the distribution and transmission infrastructure associated with said charging stations. Since batteries operate on Direct Current (DC), a rectifier (charger) is often used for converting the form of the electric power from AC to DC.

Further, external filter inductors are added to the chargers to reduce variations in electric power, thereby ensuring improved efficiency when converting AC into DC. However, external filter inductors add weight and provide an additional point of failure in the charger. Some solutions propose repurposing of coils of the electric motors to function as inductor filters. However, motors generate torque or losses when they are excited with three-phase currents, which is undesirable during charging. Such charging currents also result in the demagnetization of permanent magnets (PM) on the rotors, resulting in a decrease in the motor performance. To use motors as inductor filters, particularly when used in conjunction with three-phase inverters, phase windings of the motor have to be center tapped with all nine terminals of the motor available for connection. In such configurations magnetic fields of the current passing through the phase windings get canceled out, whereby no torque is generated. However, such configurations lower the effective inductance which increases current ripples. Additionally, such configurations necessitate the use of three H-Bridges (i.e. 6 phase inverter), which increases complexity, and correspondingly also increases cost of assembling and maintaining, thereby making such solutions less feasible. In the case of a single-phase excitation of a motor that remains stationary, the motor generates a pulsating magnetic field as opposed to the rotating field generated in three-phase excitation scenarios. Consequently, if one or two phases of the motor are adapted to function as an inductor filter, neither torque nor excessive motor losses are produced. Nevertheless, during single-phase AC/DC energy conversion, power pulses at twice the line frequency. Since power flows to the battery should desirably be smooth and devoid of power ripples, existing motors necessitate the use of a power decoupling mechanism. Existing decoupling mechanisms, however, require additional electronics such as a filter inductor, power conducting switches, and the like, thereby contributing to the overall weight and cost of the system.

Therefore, there is a need for an integrated charger unit capable of receiving and supplying power efficiently without generating undesirable torque. Further, there is a need for an integrated charger that is adaptable to charging and driving modes with minimal cost, weight, and volume/size footprint.

### SUMMARY

In an aspect, embodiments of the disclosure are directed towards charger unit. The charger unit includes a synchronous motor (such as variable flux memory motor (VFMM) or Wound field Synchronous Motor (WFSM)) having two or more phase winding sets, where the synchronous motor is operably magnetizable and de-magnetizable. The charger unit also includes one or more inverter modules configured to allow power to be supplied to the synchronous motor and/or a battery. The charger unit is operably shiftable between at least one of, a driving mode where the inverter modules supply power from the battery through the phase winding sets to drive the synchronous motor, or a charging mode where power from an external power source is received by the inverter modules through the synchronous motor and supplied to the battery for charging.

Other aspects of the disclosure will be apparent from the following description and the appended claims.

### BRIEF DESCRIPTION OF THE DRAWINGS

FIG. 1 shows a block diagram of a charger unit implemented in a vehicle, according to one or more embodiments.

FIGS. 2A, 2B, and 2C show circuit diagrams of charger units having different number of phase winding sets and corresponding inverter modules, in a driving mode, according to one or more embodiments.

FIGS. 3A and 3B show circuit diagrams of the charger unit that is in a charging mode, and is connected to a single-phase power source, where voltage capacity of battery is greater than peak voltage of a power source, according to one or more embodiments.

FIG. 3C shows a circuit diagram of the charger unit that is in the driving mode, and is connected to the single-phase power source, where voltage capacity of battery is greater than peak voltage of a power source, according to one or more embodiments.

FIGS. 4A and 4B show circuit diagrams of the charger unit that is in the charging mode, and is connected to a three-phase power source, according to one or more embodiments.

FIG. 4C shows a circuit diagram of the charger unit that is in the driving mode, and is connected to a three-phase power source, according to one or more embodiments.

FIGS. 5A and 5B show circuit diagrams of the charger unit that is in the charging mode, and is connected to the single-phase power source, where voltage capacity of battery is less than peak voltage of a power source, according to one or more embodiments.

FIG. 5C shows a circuit diagram of the charger unit that is in the driving mode, and is connected to the single-phase power source, where voltage capacity of battery is less than peak voltage of a power source, according to one or more embodiments.

FIG. 6 shows a cross-section view of the Variable Flux Memory Motor (VFMM), according to one or more embodiments.

FIG. 7A shows a graphical plot of losses from the VFMM for current supplied thereto, according to one or more embodiments.

FIG. 7B shows a graphical plot of hysteresis behavior of soft magnets of the VFMM, according to one or more embodiments.

FIG. 7C shows a graphical plot of torque generated by the VFMM when electric power is supplied thereto, according to one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it would have been apparent to one of ordinary skill in the art that the disclosure may be practiced without these specific details. In other instances, well-known features have not been described in detail to avoid unnecessarily complicating the description.

As used herein, “about” means approximately or nearly and in the context of a numerical value or range set forth means ±10% of the numeric value.

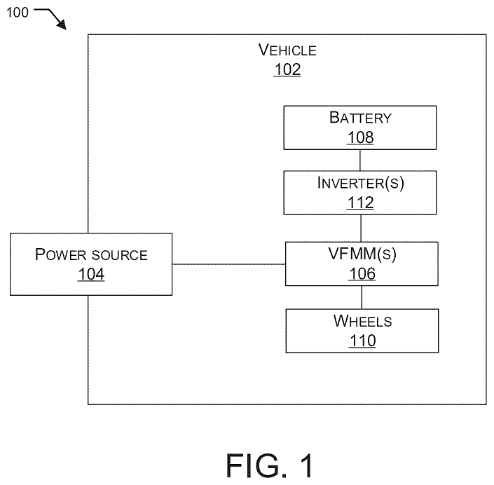

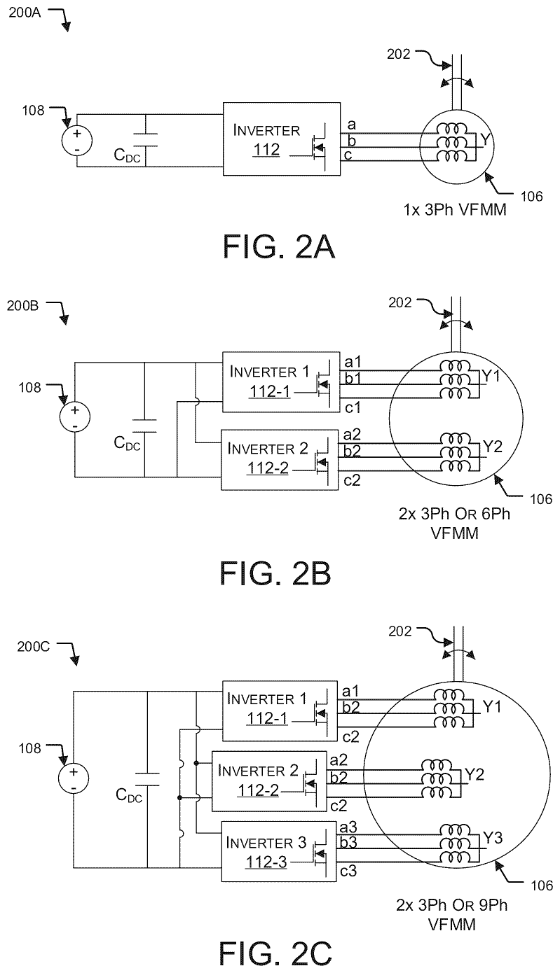

Referring to FIG. 1, a block diagram (100) of an integrated charger unit implemented in a vehicle (102) is illustrated. As shown, the charger unit may include one or more synchronous motors, such as Variable Flux Memory Motors (VFMMs) (106). In some embodiments, each of the VFMMs (106) may be connected to a corresponding mechanical load, such as a set of wheels (110). The VFMMs (106) may be configured to convert electrical energy to mechanical energy (such as rotational energy), and/or vice-versa. In some embodiments, the VFMMs (106) may be configured to propel the vehicle (102) by turning or providing the wheels (110), either directly or through a geartrain or drivetrain (such as drivetrain (202) shown in FIG. 2A to 5C). Further, the charger unit may include a battery (108) configured to store electric power/energy received from a power source (104), and supply power to the VFMMs (106) when required. While the present disclosure is described in the context of the charger being adapted for automotive implementations, it may be appreciated by those skilled in the art that the charger unit may also be suitably adapted for other non-automotive applications as well, such as industrial applications, robotics, pumps (such as in water supply systems), renewable energy systems, and the like. Further, while the present disclosure is described in the context of the synchronous motors being VFMM, embodiments of the present disclosure may be suitably adapted for use in other synchronous motors, such as Wound field Synchronous Motor (WFSM).

In some embodiments, the battery (108) may refer to any energy storage device capable of storing electrical energy in chemical, electrochemical, or physical form, and may include one or more cells, modules, stacks, or packs arranged to provide a specific voltage and capacity. The battery (108) may be a rechargeable battery, which may be chargeable by the power source (104).

The power source (104) refers to any system or device capable of supplying electrical energy to charge the battery (108). The power source (104) may include, but is not limited to, a power grid, solar panels, hydrogen fuel cells, external batteries, regenerative braking from the synchronous motor, and the like.

In one or more embodiments, the vehicle (102) may include, but not be limited to, electric vehicle, hybrid vehicle, and the like. Examples of the vehicle (102) include, but not be limited to, two-wheelers, three-wheelers, cars, vans, trucks, buses, hydraulic vehicles, electric trains, locomotives, boats, ships, and the like. The vehicle (102) may include one or more components configured to provide one or more functionalities. In some embodiments, the components may be selected from a group including, but not limited to, an e-drive motor (such as VFMMs (106)), starters of a combustion engine, a thermal heater, e-axles, inverters, exhaust pipes, batteries, chargers, compressors, variable frequency drive, and fuel cells associated with the vehicle (102). In some embodiments, the components may be powered by electrical energy, such as the energy stored in the battery (108). The charger unit may be configured to charge the battery (108) using power from the power source (104), while also enabling the battery (108) to supply power to the component during use. While the foregoing embodiments are described in the context of implementing the charger unit in vehicles (108), it may be appreciated by those skilled in the art that the charger unit may be implemented in any electrical system that requires a motor.

In one or more embodiments, the charger unit may include multiple synchronous motors, such as the VFMMs (106), and one or more corresponding inverters/inverter modules (112). In one or more embodiments, the VFMMs (106) may be indicative of synchronous electric motors whose flux linkage (λₘ) may be dynamically, and operably, adjustable. The VFMMs (106) may be a type of synchronous motor in which magnetization of rotor magnets of the VFMMs (106) may be adjusted (i.e., changed) during the operation of the VFMMs (106). The adjustment of the magnetization of the rotor magnets (hereinafter, referred to as “VFMM magnetization” or “magnetization state” for simplicity) changes the torque generated therefrom when electric power is supplied to the VFMMs (106). According to one or more embodiments, to facilitate the change in the magnetization state of the VFMMs (106), the rotor magnets may be made of a soft-ferromagnetic material including, but not limited to, aluminum nickel cobalt (AlNiCo) or some types of ceramics. Hereinafter, the rotor magnets made of a soft-ferromagnetic material will be referred to as “soft magnets.” The soft magnets may be Low Coercive Force magnets (LCF) that produce magnetomotive forces (mmf) when magnetized. According to one or more embodiments, the soft magnets may be AlNiCo with grades 1-9 or magnets made of AlNiCo, cast, ceramics, some grades of samarium cobalt, or sintered construction of these materials. It may be apparent to those skilled in the art that specific amounts of these materials may be used to achieve a desired function of the VFMMs (106). The design, construction, number, and arrangements of a stator, the rotor, and the soft magnets of the VFMMs (106) may be suitably adapted based on requirements of the use cases.

In one or more embodiments, the magnetization states of the soft magnets may be changed to any value from about 0% magnetization (i.e., the soft magnets are completely demagnetized) to about 100% magnetization (i.e., the soft magnets are magnetized to their maximum capacity). The change in the magnetization states may occur in a short time span, i.e., in about 1 millisecond. In one or more embodiments, the magnetization states of the VFMMs (106) may be changed by passing a pulse of current therethrough such that the soft magnets are magnetized or de-magnetized up to a desired level. The level of magnetization of the soft magnets may be adjusted by controlling amplitude of the pulse of current. In some embodiments, the pulse of current may be provided to the soft magnets by the battery (108) through a set of commutators. In some embodiments, the inverter modules (112) may be connected to a corresponding inverter controller (not shown) that may be configured to adjust the pulse to shift the magnetization state of the soft magnets. In some embodiments, the pulse of current from the battery (108) may be modified or channeled through the inverter modules (112).

By suitably adjusting the magnetization states of the VFMMs (106), the charger unit may be operably shifted between a charging mode and a driving mode. In some embodiments, the VFMMs (106) may allow electric power to flow between the power source (104) and the battery (108) in the charging mode. In such embodiments, the soft magnets may be demagnetized to prevent torque from being generated by the VFMMs (106) when the electric power is supplied therethrough. Further, in the driving mode, the charger unit may be configured to supply electric power from the battery (108) to the VFMM (106) (or to another load/component of the vehicle (102)). In such embodiments, the soft magnets may be re-magnetized to allow the VFMMs (106) to be energized, and enable the VFMMs (106) to generate torque. In embodiments where the synchronous motors are indicative of WFSM, a stator and a rotor thereof may be magnetically coupled in the driving mode. The intensity of magnetic fields of the rotor, and correspondingly the magnetic coupling between the stator and the rotor, may be manipulated by controllably varying electric current/pulse passed through the rotor.

In one or more embodiments, the synchronous motors, such as the VFMMs (106), may have two or more phase winding sets. The phase winding sets may be formed by grouping multiple phase windings. For example, each phase winding set may be a group of three phase windings. In one or more embodiments, the phase winding sets may be arranged in a star winding configuration. In such embodiments, each of the phase windings may be connected at a star point to form a ‘Y-shaped’ or a ‘star-shaped’ configuration (such as when the phase winding sets include three phase windings). In one or more embodiments, the phase winding sets may be connected to an external power source (such as the power source (104)) through the star point. The power source (104) may be configured to deliver power to the star points, which redirects the power to the battery (108) through the phase winding sets. In some embodiments, each leg of the multi-phase windings may be operably activated (turned on) and/or deactivated (turned off) based on the requirements (such as by the inverter module (112)).

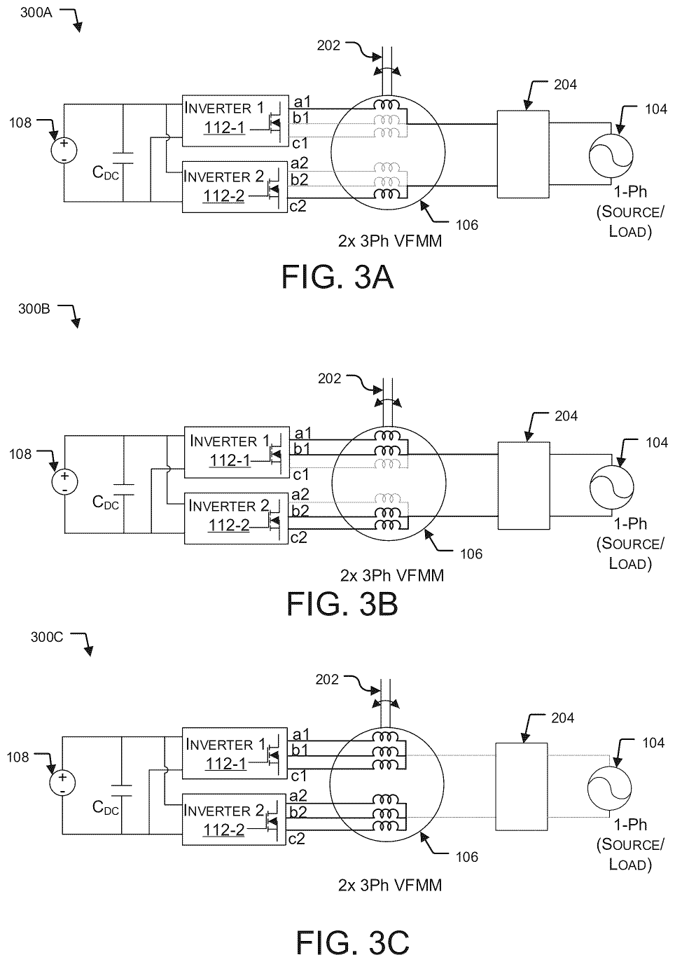

In some embodiments, in the charging mode, a subset of phase windings in each of the two or more phase winding sets is turned off, as shown in FIGS. 3A, 3B, 4A, 4B, 5A, and 5B. The number of phase windings deactivated/turned off in each phase winding set may be determined based on number of phases of the electric power being supplied by the power source (104). For example, all but one phase winding may be deactivated when the charger unit is to be adapted to operate with a single-phase power source (104). In other examples, at least three phase windings of the VFMMs (106) may be activated when the charger unit receives power from a three-phase power source (104). Switches or semiconductor dies at the inverter modules (112) may be used to controllably operably activate and/or deactivate the phase windings.

Further, in the driving mode, the charger unit may be configured to drive the VFMMs (106) using multiple ones of the inverter modules (112) sharing the same Direct Current (DC) source, i.e., through the battery (108). Each inverter module (112) may be configured to supply power to a corresponding phase winding set of the VFMMs (106). Since the phase windings may be split/grouped into multiple phase winding sets, each inverter module (112) may be capable of operating with a lower current (in comparison to a single inverter that is connected to all the phase windings). Further, having separate inverter modules (112) for each of the phase winding sets lowers the number of semiconductor dies required for operating controllably supplying power to the required phase windings in the corresponding phase winding set. In some examples, the inverter modules (112) may be configured to support three-phase power distribution through.

The voltages applied to the inverter modules (112) may be the same as in the case of symmetrical three phase windings (as in the case of the foregoing example), or different as in the case of six phase or nine phase winding configurations at the phase winding sets of the VFMMs (106). The use of multiple three-phase winding, for example, provides flexibility in the voltages applied by the inverter modules (112). For example, each inverter module (112) may be allowed to use different Pulse Width Modulation (PWM) carriers to drive the corresponding phase winding set, which can be exploited to reduce the DC current ripples, lower loss, use smaller DC capacitor, lower torque ripple, reduce noise, and increase bearing life. Furthermore, having multiple phase winding sets and corresponding inverter modules (112) may provide improved reliability and redundancy. For example, each inverter module (112) and the phase winding set may be used to limp the VFMM (106) in the event of failure.

While embodiments of the present disclosure are described in the context of each phase winding set configured to receive power from the corresponding inverter module (112), and where the phase winding sets and inverter modules (112) are homogenous in terms specification and configuration, it may be appreciated that the charger unit may be suitably adapted to have phase winding sets and inverter modules (112) that are heterogenous. For example, a first phase winding set may have three phase windings with a first inverter module adapted therefor, a second phase winding set may have six phase windings with a second inverter module adapted therefor, a third phase winding set having a single phase winding with a third inverter module adapted therefor, and so on.

In one or more embodiments, the VFMMs (106) may be electrically connected to the battery (108) on a first end of each of the phase winding sets, as shown in FIGS. 1 to 5C, via the inverter modules (112). In some embodiments, each of the phase winding sets may be connected to at least one corresponding inverter module (112), such as a first inverter module (112-1) connected to a first phase winding set, a second inverter module (112-2) connected to a second phase winding set, and a third inverter module (112-3) connected to a third phase winding set, as shown in the FIGS. 2A to 5C. While embodiments of the present disclosure show the VFMMs (106) having at least two phase winding sets, with the each phase winding set having three phase windings, it may be appreciated by those skilled in the art that the VFMMs (106) may be suitably adapted to have any number (‘n’) of phase winding sets, with each phase winding set having any number (‘m’) of phase windings. The phase configuration of the VFMMs (106) may be determined as a product of the number of phase winding sets and the phase windings therein (i.e., ‘nm’). In one or more embodiments, the VFMMs (106) may be electrically connected to the power source (104) on a second end of the phase winding sets.

In one or more embodiments, the VFMMs (106) may include one or more coils wound on the stator. The one or more coils on the stator may correspond to the phase winding sets of the VFMMs (106). In embodiments where the soft magnets are demagnetized, the coils associated with the stator may provide inductive reactance to the electric power supplied thereto, such as from the battery (108) through the corresponding inverter modules (112). Since the soft magnets are demagnetized, the VFMMs (106) may be prevented from generating torque or excessive losses when excited by the electric power from the power source (104). In some embodiments, the soft magnets may be demagnetized by passing the pulse of current through the coils associated with the stator. In such embodiments, the VFMMs (106) may operate as a filter inductor when receiving power from the power source (104), thereby reducing the current ripples due to switching of the inverter module (112). Further, by demagnetizing the VFMMs (106) based on the requirements, the need for installing filter inductors is eliminated, which reduces the weight and cost of the charger unit.

In one or more embodiments, the inverter modules (112) may be bi-directional inverters or unidirectional inverters. In some embodiments, the inverter modules (112) may be configured to allow power to be supplied therethrough, either from the battery (108) to the VFMMs (106), or from the power source (104) to the battery (108).

In one or more embodiments, in the charging mode, the bi-directional inverter modules (112) may convert the electric power from Alternating Current (AC) to DC for charging the battery (108), or vice-versa, based on direction of flow of the electric power. In some embodiments, in the driving mode, the inverter modules (112) may convert the DC from the battery (108) to the AC for actuating the synchronous motor, or vice-versa when receiving AC electric power from the power source (104) for charging the battery (108). In some embodiments, the inverter modules (112) may be configured to supply power from the battery (108) through a corresponding phase winding set of the phase winding sets. In one or more embodiments, the inverter modules (112) may include a plurality of semiconductor dies, which enable current/power to be supplied to the corresponding phase winding. The semiconductor dies may be connected in parallel to each other. However, as stated, the use of separate inverter modules (112) reduces the number of semiconductor dies required to controllably supply power to the phase windings of the corresponding phase winding set.

In some embodiments, the inverter modules (112) may be a multi-phase inverter, such as an inverter configured to support three-phase power. In some embodiments, the inverter modules (112) may be electrically connected to the VFMMs (106) and the battery (108). In some embodiments, the inverter modules (112) may be used for re-magnetizing the soft magnets in the VFMMs (106) by controllably passing a pulse of electric current through the VFMMs (106).

In one or more embodiments, the power source (104) may include a power outlet capable of providing electric power either in single-phase or in multiple phases (such as three-phase power). In some embodiments, the power source (104) may be the grid. The form of the electric power supplied by the power source (104) may depend on the distribution or transmission infrastructure associated with the power source (104). In one or more embodiments, the charger unit may further include an Electro-Magnetic Interference (EMI) filter (such as EMI filter (204) shown in FIG. 2A to 5C) that suppresses EMI from the power source (104). The EMI filter (204) may be configured between the power source (104) and the VFMMs (106) to suppress switching noise from reaching the power source (104), and assure electromagnetic compatibility according to grid codes.

In embodiments where the power source (104) supplies single-phase electric power, the phase windings of the VFMMs (106) may be suitably adapted to receive power therefrom. In such embodiments, the inverter modules (112) may be configured to receive the single-phase power from the power source (104) through the phase winding sets. In some embodiments, the charger unit may include a step-down transformer that lowers voltage of the electric power redirected to the battery (108) from the single-phase power source (104). In such embodiments, the step-down transformer lowers a peak phase voltage of the single-phase power to a voltage below that of a battery voltage capacity of the battery (108). In an example, the battery (108) may have a voltage range of about 350V-400V.

In other embodiments, the power source (104) may be configured to supply multi-phase power. In such embodiments, the inverter modules (112) may be configured to receive the multi-phase power from the power source (112). Further, in such embodiments, a peak line voltage of the multi-phase power supplied by the power source (104) may be stepped down to below the (minimum) battery voltage capacity of the battery (108) by the step-down transformer, if the supply of voltage is higher than the battery voltage capacity.

Referring to FIGS. 2A, 2B, and 2C show circuit diagrams (200A, 200B, 200C) of the charger unit in the driving mode. The charger unit may include a first, a second, and/or a third phase winding sets, each connected to the corresponding inverter modules (112-1, 112-2, 112-3). Each of the phase winding sets may have three phase windings, represented using letters ‘a,’ ‘b,’ and ‘c’ (and/or followed by a number corresponding to its phase winding set). Further, each of the phase winding set may include a corresponding star point or Y-point, represented using the letter ‘Y’ (and/or followed by a number corresponding to its phase winding set), which may be connectable to the power source (104), as shown in FIGS. 3A to 5C. The charger unit may also include a DC link capacitor connected in parallel with the inverter modules (112), for voltage stabilization, ripple suppression, shared energy storage, and the like.

For example, in the circuit diagram (200A), the charger unit includes one phase winding set having three phase windings (viz., ‘a,’ ‘b,’ and c) with a star point ‘Y’, connected to a single inverter module (112), where power may be drawn from the battery (108) to energize the VFMMs (106). Similarly, in the circuit diagram (200B), the charger unit includes a first phase winding set (with phase windings ‘a1,’ ‘b1,’ and ‘c1;) and a second phase winding set (with phase windings ‘a2,’ ‘b2,’ and ‘c2), such that the first and second phase winding sets (with the star points ‘Y1’ and ‘Y2,’ respectively), with the first and the second phase winding sets being connected to a first and second inverter modules (112-1 and 112-2), respectively, that may draw power from the battery (108) to energize the corresponding VFMMs (106). Further, in circuit diagram (200C), the charger unit includes three phase winding sets, viz., a first phase winding set (with phase windings ‘a1,’ ‘b1,’ and ‘c1’), a second phase winding set (with phase windings ‘a2,’ ‘b2,’ and ‘c2′), and a third phase winding set with phase windings 'a3,’ ‘b3,’ and ‘c3’) having the star points (such as ‘Y1,’ ‘Y2,’ and ‘Y3’, respectively), with the first, second and third phase winding sets being connected to a first, second, and third inverter modules (112-1, 112-2, and 112-3), respectively, to draw power from the battery (108) to energize the VFMMs (106).

In the driving mode, the soft magnets/rotor magnets in the VFMMs (106) may be magnetized. When power is supplied from the battery (108) to the phase winding sets through the inverter module (112), the phase windings sets may be energized and may produce rotating magnetic fields that interact that of the rotor magnets. The interaction between the magnetic fields from the phase winding sets and the rotor magnets may cause the rotor to rotate, and drive the drivetrain (202). The drivetrain (202) may be connected to the wheels (110) of the vehicle (102), or any other mechanical load in requirement of rotational energy.

In one or more embodiments, the star points (such as ‘Y1,’ ‘Y2,’ and ‘Y3’) may be used to connect the charger unit to the power source (104), and shift the charger unit to the charging mode. In some embodiments, the star points may be connected to charging ports or outlets associated with the power source (104). Further, to shift the charger unit to the charging mode, the rotor magnets in the VFMMs (106) may be demagnetized, using a pulse of current modulated by the inverter module (112) (or a controller thereof), thereby allowing the VFMMs (106) to operate as filter inductors. Demagnetizing the soft magnets may also prevent the VFMMs (106) from generating torque when the electric power is passed therethrough.

The charger unit may be operably adapted to receive power in any phase supported by the power source (104). Circuit diagrams (300A to 500C) of the charger unit when operating with different power phases are shown in FIGS. 3A to 5C.

Referring to circuit diagrams (300A, 300B) of FIGS. 3A and 3B, the charger unit may be configured to operate on single-phase power provided by the power source (104). The charger unit may include the first and the second inverter modules (112-1, and 112-2) connected to corresponding first and second phase winding sets, to support a six-phase VFMM (106). In some embodiments, the star points of the phase winding sets may be connected to the power source (104), such as through the EMI filter (204). The power source (104) may be configured to supply single phase power to the charger unit, for charging the battery (108). In some embodiments, the battery (108) may be selected such that minimum battery voltage capacity of the battery (108) is higher than the peak phase voltage provided by the power source (104). The use of batteries (108) with (high) battery voltage may widen the compatibility of the charger unit with any network/power source (104). In such embodiments, if the AC supply is higher than the battery voltage, the step-down transformer may be used at the power source (104) to reduce the voltage of the AC supply.

As shown in FIGS. 3A and 3B, in such embodiments, although the phase winding sets may have three phase windings, with only one or two legs/phase windings may be activated (such as phase windings ‘a1,’ and ‘c2,’ as shown in circuit diagram (300A), or phase windings ‘a1,’ ‘b1,’ ‘b2,’ and ‘c2,’ as shown in circuit diagram (300B)), thereby allowing such phase winding sets to receive power from the single-phase power sources (104). Since the rotor magnets are demagnetized in the charging mode, the charger unit may not require active cancellation of the magnetic fields arising from the flow of single-phase power from the power source (104) through the phase windings. The charger unit exploits zero sequence components and low leakage inductance in the VFMMs (106) that arise due to unbalanced activation of phase windings, eliminating the need for using other components to remove or suppress the magnetic fields generated during charging. With some of the phases deactivated, the resultant magnetic field may not fully cancel out, which reduces switching ripple currents in the active phases and increases the effective inductance experienced by the inverter modules (112), leading to smoother current flow and improved performance.

Referring to circuit diagram (300C) of FIG. 3C, the charger unit may be disconnected from the power source (104) (from the star point thereof) in the driving mode. In such embodiments, the battery (108) may supply power to all three phase windings of each phase winding set to operate the six-phase VFMMs (106).

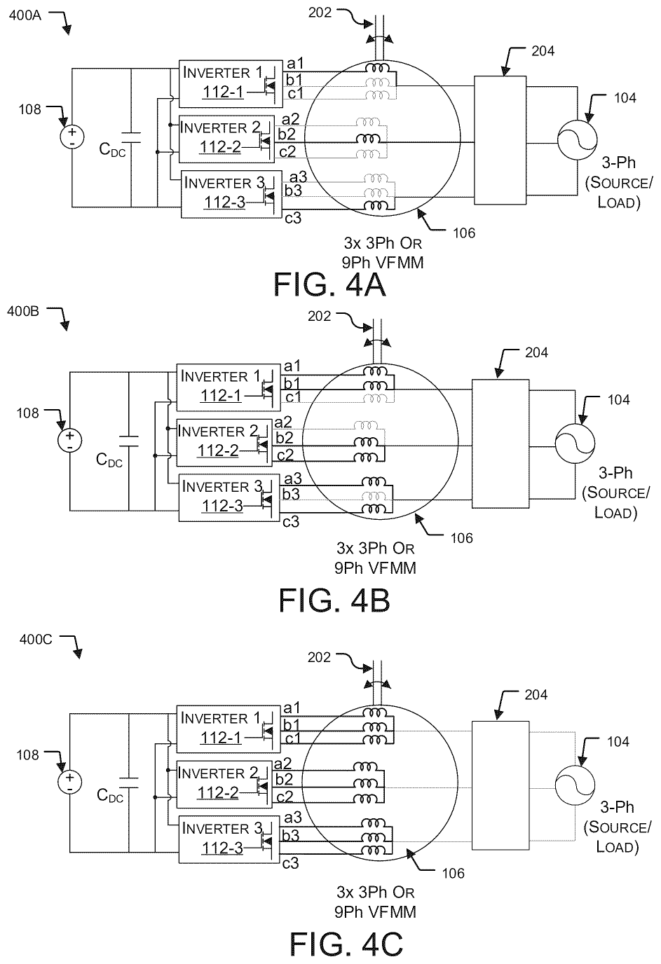

Referring to circuit diagrams (400A, 400B) of FIGS. 4A and 4B, the charger unit may be configured to operate on three-phase power provided by the power source (104). The charger unit may include the first, the second, and the third inverter modules (112-1, 112-2, and 112-3) connected to corresponding first, second, and third phase winding sets, to support a nine-phase VFMM (106). In some embodiments, the star points of the phase winding sets may be connected to the power source (104), such as through the EMI filter (204). The power source (104) may be configured to supply three-phase power to the charger unit, for charging the battery (108). In some embodiments, the battery (108) may be a high voltage battery, which has the(minimum) battery voltage capacity higher/greater than the peak phase voltage of the three-phase power provided by the power source (104). In some embodiments, the step-down transformer may be used at the power source (104) to reduce the voltage of the AC supply. In other embodiments, a single-phase mode with decoupling method when the battery voltage capacity is lower than voltage limit.

As shown in FIGS. 4A and 4B, in such embodiments, although the phase winding sets may have three phase windings, with only one or two legs/phase windings may be activated (such as phase windings ‘al,’ ‘b2,’ and ‘c3,’ as shown in circuit diagram (400A), or phase windings ‘a1,’ ‘b1,’ ‘b2,’ ‘c2,’ ‘a3,’and ‘c3,’ as shown in circuit diagram (400B)), thereby allowing such phase winding sets to receive power from the three-phase power sources (104). Since the rotor magnets are demagnetized in the charging mode, the charger unit may not require active cancellation of the magnetic fields arising from the flow of three-phase power, which the charger unit may exploit to eliminate the need to suppress the magnetic fields generated during charging, reduce switching ripple currents in the active phases, and increase the effective inductance experienced by the inverter modules (112), leading to smoother current flow and improved performance.

Referring to circuit diagram (400C) of FIG. 4C, the charger unit may be disconnected from the power source (104) (from the star point thereof) in the driving mode. In such embodiments, the battery (108) may supply power to all three phase windings of each phase winding set to operate the nine-phase VFMMs (106).

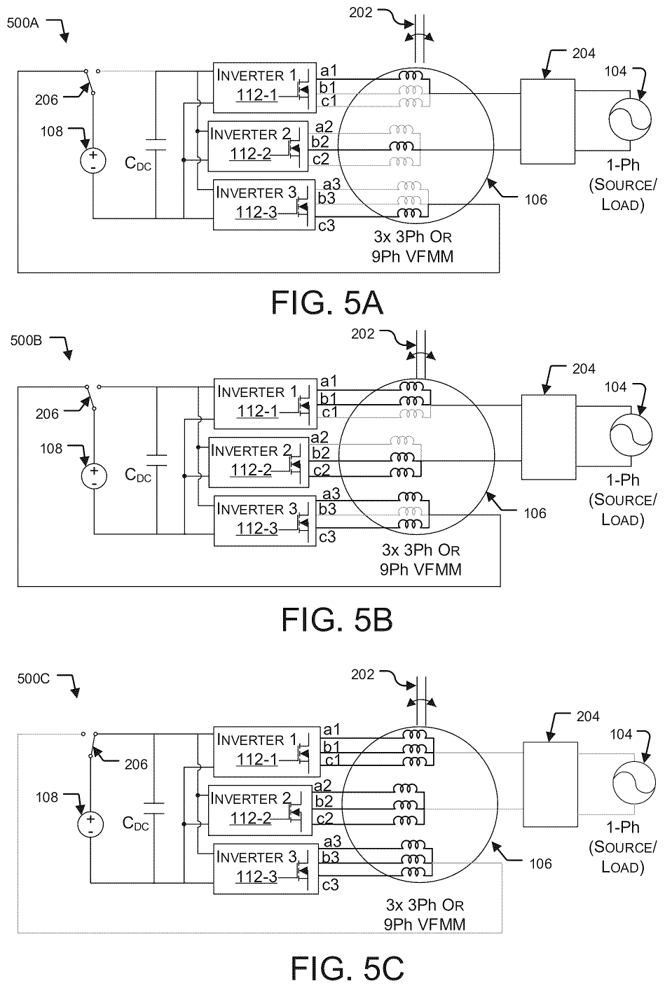

Referring to circuit diagrams (500A, 500B) of FIGS. 5A and 5B, the charger unit may be configured to operate on single-phase power provided by the power source (104). The charger unit may include the first, the second, and the third inverter modules (112-1, 112-2, and 112-3) connected to corresponding first, second, and third phase winding sets, to support a nine-phase VFMM (106). In some embodiments, the star points of the phase winding sets may be connected to the power source (104), such as through the EMI filter (204). The power source (104) may be configured to supply three-phase power to the charger unit, for charging the battery (108). In some embodiments, the battery (108) may be a low voltage battery, which does not require the minimum battery voltage capacity of the battery to be higher than the peak phase voltage of the three-phase power provided by the power source (104). In such embodiments, only the first and the second phase winding sets may be connected to the power source (104), and at least one of the phase winding sets (such as the third phase winding set) may be operably connected through a switch (206) from the star point thereof to decouple the battery from the power source (104), in the charging mode. In some embodiments, the switch (206) may be configured to connect the third phase winding set to the battery (108) and disconnect the battery (108) from all of the inverter modules (112), in the charging mode. In other embodiments, the switch (206) may be configured to disconnect the third phase winding set from the battery (108), and connect the battery (108) to all of the inverter modules (112), in the driving mode. Such configurations may enable the charger unit to adhere to the acceptable voltage range limitations with respect to the voltage of the battery (108), and regulate power flow to the battery (108) while cancelling the power ripples at double line frequencies.

As shown in FIGS. 5A and 5B, in such embodiments, although the phase winding sets may have three phase windings, with only one or two legs/phase windings may be activated (such as phase windings ‘a1,’ ‘b2,’ and ‘c3,’ as shown in circuit diagram (500A), or phase windings ‘a1,’ ‘b1,’ ‘b2,’ ‘c2,’ ‘a3,’ and ‘c3,’ as shown in circuit diagram (500B)), and allow the first and the second phase winding sets to receive power from the single-phase power sources (104). In the embodiments shown in FIGS. 5A and 5B, the first and the second phase windings may operate similarly to the embodiments shown in FIGS. 3A and 3B. Since the rotor magnets are demagnetized in the charging mode, the charger unit may not require active cancellation of the magnetic fields arising from the flow of three-phase power to provide zero sequence components and low leakage inductance, which the charger unit may exploit to eliminate need or suppress the magnetic fields generated during charging, reduce switching ripple currents in the active phases, and increase the effective inductance experienced by the inverter modules (112), leading to smoother current flow and improved performance.

Referring to circuit diagram (500C) of FIG. 5C, the charger unit may be disconnected from the power source (104) (from the star point thereof) in the driving mode. In such embodiments, the battery (108) may supply power to all three phase windings of each phase winding set to operate the nine-phase VFMMs (106). Further, in such embodiments, the switch (206) may be configured to disconnect the connection between the third phase winding set and the battery (108).

As stated, the charger unit may be operably shifted between the charging mode and the driving mode, based on whether the battery (108) is to be charged or discharged. In the driving mode, the VFMMs (106) may consume power from the battery (108), to convert electrical power to kinetic energy. In the charging mode, the VFMMs (106) may operate as filter inductors while allowing the charger unit to receive power from the power source (104) to charge the battery (108). To shift to the charging mode, the VFMM (106) may be demagnetized (using a pulse of current) to prevent torque generation at the rotor of the VFMM (106), and the phase winding sets are connected to the power source (104). To shift to the driving mode, the VFMM (106) may be re-magnetized (using a pulse of current) to drive the rotor, and the phase winding sets are supplied with power from the battery (108) through the inverter modules (112).

In some embodiments, the charger unit may be adapted for providing regenerative braking functionality. In such embodiments, the VFMMs (106) may be operably shifted to a regenerative charging mode, where the VFMMs (106) may be adapted to convert kinetic energy into electric power. The electric energy/power regenerated may be stored in the battery (108). In such embodiments, the electric energy may be generated at the VFMMs (106), using the rotational energy of the wheels (110) (and correspondingly the rotation of the rotors).

In other embodiments, the electric energy generated through other means, such as generators, regenerative braking, hydrogen fuel cells, solar panels, and the like, may also be stored in the battery (108). Such other means may be connected to the VFMMs (106) (which act like filter inductors) similarly to the power source (104).

In other embodiments, the charger unit may be operably shiftable to a power supplying mode where the charger unit may be configured to supply electric power to the external power source. The energy generated may be energy stored in the battery (108), which may be supplied to the external power source (104), such as the grid. In such embodiments, the charger unit may be adapted to vehicle-to-load (V2L), vehicle-to-home (V2H), vehicle-to-vehicle (V2V), vehicle-to-grid (V2G), and generally to vehicle-to-everything (V2X) applications, without adding dedicated or purpose specific electronic elements.

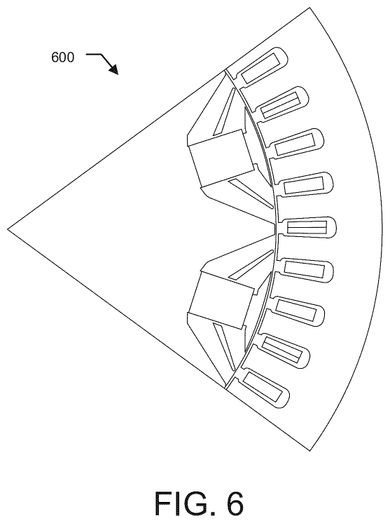

FIG. 6 shows a cross-section view (600) of the VFMMs (106), according to one or more embodiments. As shown, when the soft magnets of the VFMMs (106) are demagnetized, the VFMMs (106) may be prevented from generating a magnetic field, and, in turn, be prevented from generating torque. In such embodiments, the rotor may be locked in position, thereby allowing the electric power to be filtered without risk of generating torque during charging. While an example design of the VFMMs (106) is shown in FIG. 6, it may be appreciated by those skilled in that that the VFMMs (106) used by the charger unit may be suitably adapted based on the requirements of the load (such as of the vehicle (102)).

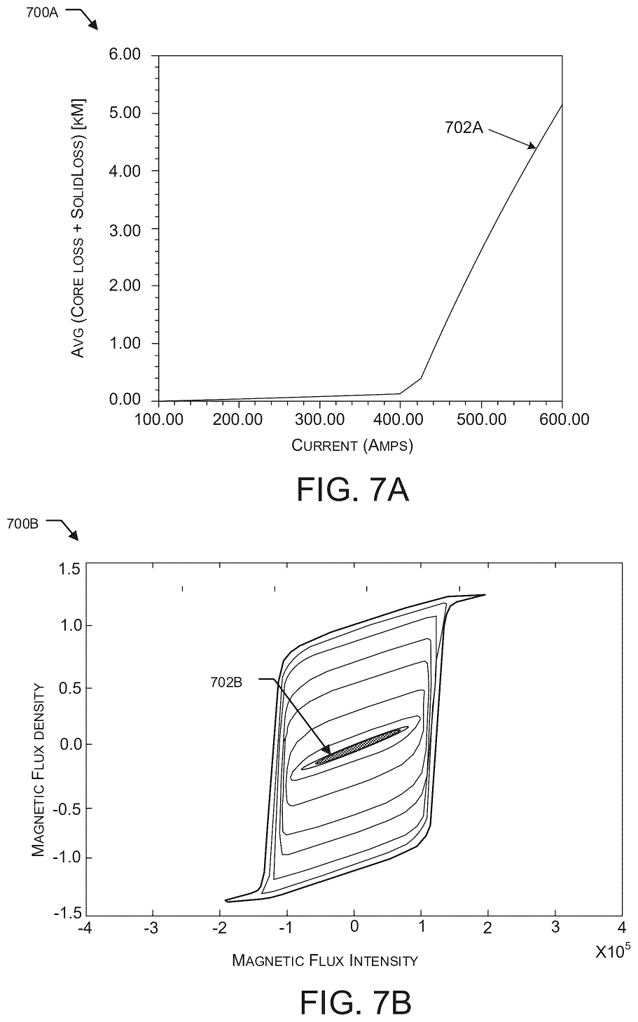

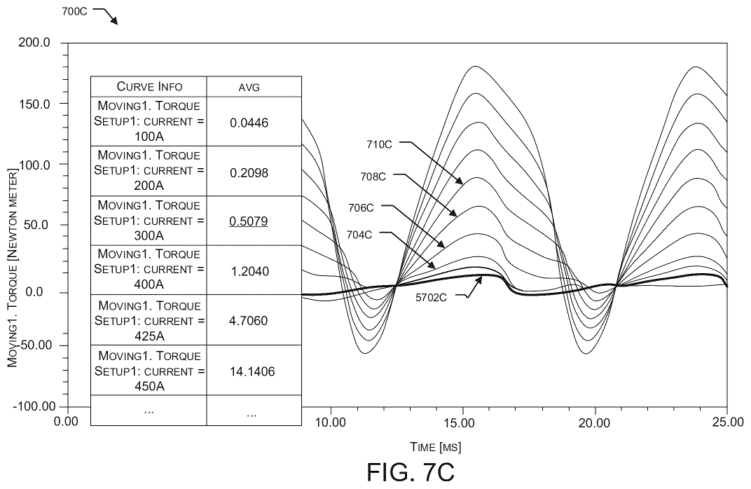

FIG. 7A shows a graphical plot (700A) of losses from the VFMMs (106) for current supplied thereto, according to one or more embodiments. The graphical plot (700A) shows a line (702A) indicating the losses at a plurality of magnitudes of the electric current, when the soft magnets are demagnetized. As shown, the losses may be below a predetermined acceptable threshold, when the magnitude of electric current supplied thereto is less than a threshold level. The losses may increase beyond the acceptable threshold as the electric current increases, beyond which the losses may no longer be acceptable. In a preferred example, the losses may be below the acceptable threshold when the electric current is less than about 400 A.

FIG. 7B shows a graphical plot (700B) of hysteresis behavior of soft magnets of the VFMMs (106), according to one or more embodiments. The graphical plot particularly shows the hysteresis behavior of soft magnets made of AlNiCo. As shown, the magnetic hysteresis loops may indicate the field intensity (H) and the magnetic flux (B) oscillates around 0 in a straight line as shown by region (702B), when the electric current is sufficiently low, i.e. less than about 400 A. Furthermore, the hysteresis behaviour may be steeper than existing solutions.

FIG. 7C shows a graphical plot (700C) of developed torque from the VFMMs (106) for the electric power supplied thereto, according to one or more embodiments. The graphical plot is indicative of a torque plot of the torque generated by the VFMMs (106) with respect to the electric power supplied thereto. As shown, the line plots (702C to 710C) correspond to torques generated at electric currents at 300 A, 400 A, and at 25 A increments from 400 A respectively, within a predetermined interval. The torque generated at up to about 400 A is acceptably low for providing charging functionality, and hence may form the preferred ranges for the electric current.

The use combination of the inverter (112) and the VFMMs (106) in conjunction with the other may allow for charging functionality with a simpler circuit design that requires minimal electronics. Further, the charger unit of the present disclosure minimizes the weight and complexity of the circuit design thereof, and eliminates the need for external filter inductors. Furthermore, the charger provides for means for charging batteries with both single-phase, as well as three-phase electric power from the power source (104). Additionally, the use of separate inverter modules (112) serving different phase winding sets may provide flexibility for the charger unit to handle single-phase power or any multi-phase power.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. An charger operable with a power source and a battery, the charger comprising:
a synchronous motor comprising at least two phase winding sets; and
at least one inverter that operably couples the power source with at least one of the synchronous motor and the battery,
wherein the charger is operably configured to shift between at least one of:
a driving mode where the at least one inverter operably couples the battery through the at least two phase winding sets to drive the synchronous motor; and
a charging mode where the at least one inverter operably couples the synchronous motor with the battery for charging.

2. The charger of claim 1, wherein each phase winding set of the at least two phase winding sets comprises a multi-phase winding.

3. The charger of claim 2, wherein the multi-phase winding comprises a three-phase winding.

4. The charger of claim 1, wherein the at least two phase winding sets comprise a star winding configuration.

5. The charger of claim 4, wherein the star winding configuration comprises a star point operably coupled with the power source.

6. The charger of claim 1, wherein the at least one inverter operably couples the battery with a corresponding phase winding set of the at least two phase winding sets.

7. The charger of claim 6, wherein the at least one inverter comprises a plurality of semiconductor dies coupled with the corresponding phase winding.

8. The charger of claim 1, wherein the at least one inverter operably couples a single-phase power from the power source.

9. The charger of claim 1, wherein a subset of phase windings of each of the at least two phase winding sets is operably decoupled in the charging mode.

10. The charger of claim 1, wherein, the power source is operably decoupled from the battery in the charging mode.

11. The charger of claim 1, further comprising a switch operably configured to at least one of:
couple one phase winding set of the at least two phase winding sets with the battery and decouple the battery from at least one inverter in the charging mode; or
decouple the phase winding set from the battery and couple the battery to the at least one inverter in the driving mode.

12. The charger of claim 1, wherein the at least one inverter is configured to receive a multi-phase power from the power source.

13. The charger of claim 1, wherein the at least one inverter comprises at least one bidirectional inverter.

14. The charger of claim 1, wherein:
the synchronous motor is operably demagnetized to prevent torque generation at a rotor of the synchronous motor and the at least two phase winding sets are operably coupled with the power source to enable the charging mode.

15. The charger of claim 1, wherein the synchronous motor comprises at least one coil wound on a stator, the at least one coil operably providing inductive reactance to the power source and operably opposing torque generation by the de-magnetized synchronous motor.

16. The charger of claim 1, further comprising an Electro-Magnetic Interference (EMI) filter that operably suppresses switching noise from reaching the power source and operably provides electromagnetic compatibility according to grid codes.

17. The charger of claim 1, wherein the charger is operably configured to shift to a power supplying mode to supply power to the power source.

18. The charger of claim 1, wherein the charger is operably configured to shift to a regenerative charging mode to operably configure the synchronous motor is to generate and power to charge the battery.

19. The charger of claim 1, wherein the synchronous motor comprises at least one of a variable flux memory motor (VFMM) and a Wound field Synchronous Motor (WFSM).

20. The charger of claim 8, wherein a peak phase voltage of the single-phase power is operably coupled with a step-down transformer.

21. The charger of claim 20, wherein the step-down transformer operably steps down the peak phase voltage to below a voltage capacity of the battery.

22. The charger of claim 12, wherein a peak line voltage of the multi-phase power is operably coupled with a step-down transformer.

23. The charger of claim 22, wherein the step-down transformer operably steps down the peak line voltage to below a voltage capacity of the battery in response to a step down signal.

24. The charger of claim 23, wherein the step down signal is operably triggered if a voltage of the power supply is higher than the voltage capacity of the battery.

25. The charger of claim 14, wherein the synchronous motor is operably re-magnetized to drive the rotor and the at least two phase winding sets are operably coupled with the battery and the at least one inverter to enable the driving mode.

26. The charger of claim 15, wherein the synchronous motor operates as a filter inductor to the at least one inverter.
